(19) United States
(12) Patent Application Publication
(10) Pub. No.: US 2014/0011514 A1
(43) Pub. Date: Jan. 9, 2014

(54) LOCATION INFORMATION REPORT VIA PAYLOAD DATA TRAFFIC

(71) Applicants: Hui GU, Shanghai (CN); Kenneth BARASCIUTTI, Jarfalla (SE); Pernilla BORGLIN, Savedalen (SE)

(72) Inventors: Hui GU, Shanghai (CN); Kenneth BARASCIUTTI, Jarfalla (SE); Pernilla BORGLIN, Savedalen (SE)

(73) Assignee: TELEFONAKTIEBOLAGET L M ERICSSON (publ), Stockholm (SE)

(21) Appl. No.: 13/540,669

(22) Filed: Jul. 3, 2012

(51) Int. Cl. H04W 4/02

(52) U.S. Cl. CPC H04W 4/02
USPC 455/456.1

(57) ABSTRACT

The embodiments herein relates to a method in a radio access network node for transmitting location information associated with a user equipment to a first core network node in a communications network. The radio access network node transmits the location information to the first core network node using a General packet radio service Tunneling Protocol-User plane, GTP-U, protocol. The location information is enclosed in a GTP-U header of payload data traffic.

### TECHNICAL FIELD

Embodiments herein relate generally to a Radio Access Network (RAN) node and a method in the radio access network node. More particularly the embodiments herein relate to transmitting location information associated with a User Equipment (UE) to a first Core Network (CN) node in a communications network.

### BACKGROUND

In a typical cellular network, also referred to as a wireless communication system, user equipment's, communicate via the radio access network to one or more core networks.

A user equipment is a device by which a subscriber may access services offered by an operator's core network and services outside the operator's network to which the operator's radio access network and core network provide access, e.g. access to the Internet. The user equipment may be any device, mobile or stationary, enabled to communicate over a radio channel in the communications network, for instance but not limited to e.g. mobile phone, smart phone, sensors, meters, vehicles, household appliances, medical appliances, media players, cameras, or any type of consumer electronic, for instance but not limited to television, radio, lighting arrangements, tablet computer, laptop, or PC. The user equipment may be portable, pocket-storable, hand-held, computer-comprised, or vehicle-mounted mobile devices, enabled to communicate voice and/or data, via the radio access network, with the core network.

The radio access network covers a geographical area which is divided into cell areas, with each cell area being served by a base station, e.g. a Radio Base Station (RBS), which in some radio access networks is also called eNodeB (eNB), NodeB, B node or base station. A cell is a geographical area where radio coverage is provided by the base station at a base station site. The base stations communicate over the air interface operating on radio frequencies with the user equipment's within range of the base stations.

The location based service becomes the top ranked service in these years, for example, mobile maps, emergency call positioning, local search, advertising, self-location, location based charging, etc. With those increasing market demanding, the user equipment's location information becomes more and more interesting and attractive to the operators. The accurate and timely location report from the radio access network, the core network to an Online Charging System (OCS) and a Policy and Charging Rules Function (PCRF), is highly wanted by the operators. The OCS is a system or a node allowing a communications service provider to charge their customers, in real time, based on service usage. The PCRF is a node, operating in the core network, that encompasses policy control decision and flow based charging control functionalities.

Currently in the Third Generation Partnership Project (3GPP), there are two kinds of location reporting procedures defined for the location service:
Solution 1, the best-effort location reporting procedure, in which the location information is reported in the available session procedures without any location dedicated signaling procedures.
Solution 2, the timely location change reporting procedure, in which the location information is reported in a dedicated signaling procedure.

FIG. 1 is a signaling diagram illustrating the signaling based location reporting procedure for solution 1 and 2.

Preparation stage: From Steps 101˜106, the OCS/PCRF orders the location change reporting for a user equipment during this user equipment's mobility or session procedures, for example attach, Packet Data Protocol (PDP) context activation, etc. The OCS and the PCRF are two separate nodes.

Execution stage, from steps 100a˜100c, the radio access network node reports the changed location information to OCS/PCRF once this user equipment's location is changed. The location may be a Cell Global Identity (CGI) in a Global System for Mobile Communication (GSM) network, a Service Area Identifier (SAI) in a Wideband Code Division Multiple Access (WCDMA) network, or E-UTRAN Cell Global Identifier/Tracking Area Identity (ECGI/TAI) in a Long Term Evolution (LTE) network. E-UTRAN is the abbreviation for Evolved Universal Terrestrial Radio Access Network. The radio access network node is referred to as a RAN node in some of the drawings.

According to the 3GPP, the CGI is the concatenation of the Location Area Identification (LAI) and the Cell Identity (CI). The base station system and the cell within the base station system are identified within a location area or routing area by adding the cell identity to the location area identification or the routing area identification.

SAI is defined by the 3GPP to be used to identify an area comprising one or more cells belonging to the same Location Area. Such an area is called a Service Area and may be used for indicating the location of a user equipment to the core network.

In an LTE network, the ECGI is a concatenation of a PLMN Identifier (PLMN-ID) and the E-UTRAN Cell Identity (ECI). The TAI is used to identify a Tracking Area (TA). A tracking area is a Tracking a logical grouping of cells in a LTE network.

When the OCS/PCRF receives the user equipment location information, the OCS/PCRF starts the location based charging or policy control, for example, initiates the Quality of Service (QoS) modification.

The procedure in FIG. 1 comprises the following steps, which steps may be performed in any suitable order:

### Step 101

The OCS/PCRF sends a Location Report Start Request to the GGSN/SGW/PGW. Which of the nodes GGSN, SGW or PGW the request is sent to is dependent on whether the communications network is a GSM network, a WCDMA network or a LTE network. In a GSM or a WCDMA network, the Location Report Start Request is sent to the GGSN. In a GSM or WCDMA or LTE, the Location Report Start Request is sent to the SGW/PGW. The Location Report Start Request comprises a user equipment ID. The user equipment ID may also be referred to as subscriber ID. The user equipment ID may be an International Mobile Subscriber Identity (IMSI), Mobile Station International Subscriber Directory Number (MSISDN), International Mobile Equipment Identity (IMEI), etc. In some embodiments, the GGSN, SGW and the PGW are three separate nodes or they may be co-located in one node. The location Report Start request may be for example a CCA Initial message or a CCA Update message. CCA is short for Credit Control Answer.

GGSN is short for Gateway GPRS Support Node and is a core network node acting as a gateway between the GPRS network and an external Packet Data Network (PDN). The GGSN provides network access to external hosts wishing to communicate with the user equipment. GPRS is short for General Packet Radio Service.

SGW is short for Serving GateWay and is a gateway in the core network which routes and forwards user data packets. The SGW also acts as a mobility anchor during inter-eNB handovers and as a mobility anchor for mobility between LTE and other 3GPP technologies.

PGW is short for PDN GateWay and is a gateway that provides connectivity from the user equipment to an external PDN. The PGW is the point of exit and entry for data traffic for the user equipment. The user equipment may have simultaneous connectivity with more than one PGW for accessing multiple PDNs. Another function of the PGW is to act as the anchor for mobility between 3GPP and non-3GPP technologies.

### Step 102

Upon receipt of the Location Report Start Request, the GGSN/SGW/PGW sends a Location Report Start Response back to the OCS/PCRF confirming that it has received the Location Report Start Request.

### Step 103

The GGSN/SGW/PGW forwards the Location Report Start Request comprising the user equipment ID to the SGSN-MME. SGSN is short for Serving GPRS Support Node and is a main component of the GPRS core network. The SGSN handles all packet switched data within the network, e.g. the mobility management and authentication of the user equipment. The MME is short for Mobility Management Entity and is a core network node responsible for mobility in the core network. The SGSN and the MME is co-located in one node.

### Step 104

Upon receipt of the Location Report Start Request, the SGSN-MME sends a Location Report Start Response back to the GGSN/SGW/PGW.

### Step 105

The SGSN-MME forwards the Location Report Start Request comprising the user equipment ID to the radio access network node.

### Step 106

Upon receipt of the Location Report Start Request, the radio access network node sends a Location Report Start Response back to the SGSN-MME. With this step, the preparation stage where the OCS/PCRF asks for Location Reporting per user equipment is finished.

### Step 100a

After the preparation stage in steps 101-106 has been completed, the execution stage starts which involves reporting of the user equipment location once the location has changed, i.e. the user equipment is moving. Step 100a may start directly after step 106 or it may start a time period after step 106.

The radio access network node is referred to as a RAN node in some of the drawings sends a Location User Equipment Report to the SGSN-MME when the location of the user equipment has changed. The Location User Equipment Report comprises a user equipment ID and the Location Information. The Location User Equipment Report may also be referred to as a Location Subscriber Report.

### Step 100b

The SGSN-MME forwards the Location User Equipment Report comprising the user equipment ID and the Location Information to the GGSN/SGW/PGW.

### Step 100c

The GGSN/SGW/PGW forwards the Location User Equipment Report comprising the user equipment ID and the Location Information to the OCS/PCRF. This completes the first part of the execution stage.

The second part of the execution stage takes place directly or a time after step 100c has been completed. In the second part, the OCS/PCRF triggers the GGSN/SGW/PGW to initiate the PDP Context/Evolved Packet System (EPS) bearer modification to update the QoS, for this user equipment.

There are mainly two problems in these existing solutions:

The first problem is that both of the above two solutions 1 and 2 are based on the signaling procedures. These signaling procedures for location reporting will overload the network more or less.

The second problem is that only a limited number of user equipment's may be served with the location based service. The OCS and the PCRF may only deploy the different charging or policy control for some pre-defined user equipment's based on their location information. The number of these pre-defined user equipment's will not be too high. If the number of pre-defined user equipment's is too high, the signaling for the location reporting for these user equipment's will overload the radio access network, the core network, the OCS and the PCRF.

The Pros and Cons of the existing solutions are listed in the below table 1:

TABLE 1

| Solution | Pro | Con |
|---|---|---|
| Solution 1: Best- | No dedicated signaling | The location |
| effort location | is needed between | information, sent to |
| reporting | RAN, SGSN-MME and | OCS and PCRF, is not |
| procedure | GGSN/SGW/PGW. | the latest. |
| Solution 2: | The location | The dedicated signaling |
| Timely location | information, sent to | is needed and more |
| change reporting | PCRF and OCS, is the | signaling between RAN, |
| procedure | latest. | and core network |
| | | compared with Solution 1. |

A disadvantage of the existing solutions is that they require a large amount of signaling between the radio access network, the core network and the PCRF/OCS.

In order to achieve the location reporting from end to end, a large amount of control-plane signaling must be supported from end to end, for example, lu-C, S1-MME, GTPv1, GTPv2. lu-C is the interface that connects the Radio Network Controller (RNC) to the SGSN. MME is the interface between the MME and the eNB. GTP is short for GPRS Tunneling Protocol.

With the existing location reporting procedures, another disadvantage is that only a limited amount of user equipment's may enjoy the service of location reporting.

Another disadvantage is that the location reporting is inefficient and the implementation costs for the radio access network and the core network is high. Another disadvantage is that the location reporting stops cannot be decreased.

### SUMMARY

An objective of embodiments herein is therefore to obviate at least one of the above disadvantages and to provide improved location reporting in the communications network.

According to a first aspect, the object is achieved by a method in a radio access network node for transmitting location information associated with a user equipment to a first core network node in a communications network. The radio access network node transmits the location information to the first core network node using a General packet radio service Tunneling Protocol-User plane, GTP-U, protocol. The location information is enclosed in a GTP-U header of payload data traffic.

According to a second aspect, the object is achieved by a radio access network node for transmitting location information associated with a user equipment to a first core network node in a communications network. The radio access network node comprises a transmitter which is configured to transmit the location information to the first core network node using the GTP-U protocol. The location information is enclosed in a GTP-U header of payload data traffic.

Since the location information is enclosed in the payload data traffic and sent from the radio access network node to the first core network node using the GTP-U protocol, the location reporting in the communications network is improved.

Embodiments herein afford many advantages, of which a non-exhaustive list of examples follows:

An advantage of the embodiments herein is that they will decrease the signaling for the location reporting from end to end, i.e. between the radio access network node, the first core network node and the PCRF/OCS. It will help the operators to have more and more attractive location based services put into use.

Another advantage is that a larger number of user equipment's may enjoy the service.

With the embodiments herein, an advantage is that the location reporting is efficient and in real-time.

Another advantage is that only the GTP-U based payload data traffic is impacted by the embodiments herein and that is only necessary to add some new octets into the GTP-U header of each payload data packet.

Another advantage of the embodiments herein is that their implementation cost for the radio access network and the, core network is low.

Another advantage is that the location reporting stops can be decreased (in case of 3GDT and LTE access network.)

The embodiments herein are not limited to the features and advantages mentioned above. A person skilled in the art will recognize additional features and advantages upon reading the following detailed description.

### BRIEF DESCRIPTION OF THE DRAWINGS

The embodiments herein will now be further described in more detail in the following detailed description by reference to the appended drawings illustrating the embodiments and in which:

FIG. 1 is a signaling diagram illustrating an embodiment of a signaling based location reporting procedure.

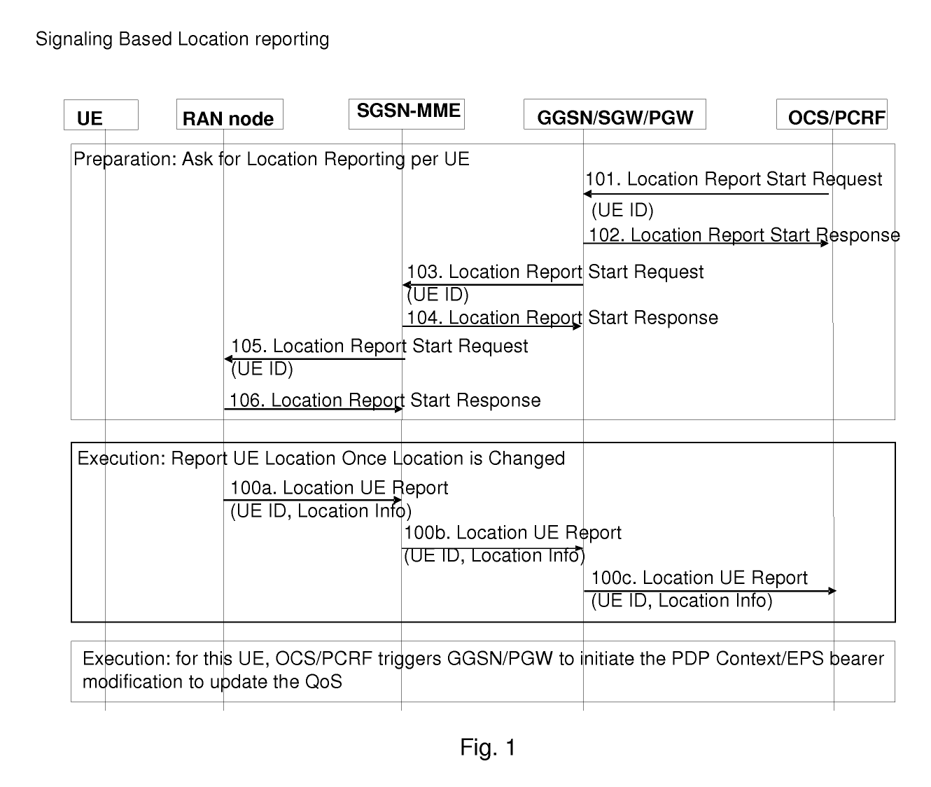

FIG. 2 is a block diagram illustrating an embodiment of a communications network.

FIG. 3 is a signaling diagram illustrating an embodiment of a payload based location reporting procedure.

FIG. 4 is a schematic block diagram illustrating an embodiment of User Location Information.

FIG. 5 is a schematic block diagram illustrating an embodiment of a GTP-U Header.

FIG. 6 is a schematic block diagram illustrating an embodiment of a payload based location report from GERAN to SGSN to GGSN.

FIG. 7 is a schematic block diagram illustrating an embodiment of a payload based location report from GERAN to SGSN to SGW to PGW.

FIG. 8 is a schematic block diagram illustrating an embodiment of a payload based location report from UTRAN to SGSN to GGSN.

FIG. 9 is a schematic block diagram illustrating an embodiment of a payload based location report from UTRAN to GGSN via Direct Tunnel.

FIG. 10 is a schematic block diagram illustrating an embodiment of a payload based location report from UTRAN to SGSN to SGW to PGW.

FIG. 11 is a schematic block diagram illustrating an embodiment of a payload based location report from UTRAN to SGW to PGW via Direct Tunnel.

FIG. 12 is a schematic block diagram illustrating an embodiment of a payload based location report from E-UTRAN to SGW to PGW.

FIG. 13 is a flow chart illustrating embodiments of a method in a radio access network node.

FIG. 14 is a schematic block diagram illustrating embodiments of a radio access network node.

The drawings are not necessarily to scale and the dimensions of certain features may have been exaggerated for the sake of clarity. Emphasis is instead placed upon illustrating the principle of the embodiments herein.

### DETAILED DESCRIPTION

The embodiments herein relate to transfer the user equipment's location information between the radio access network and the core network by using the payload data traffic, through the extension header in each GTP-U packets.

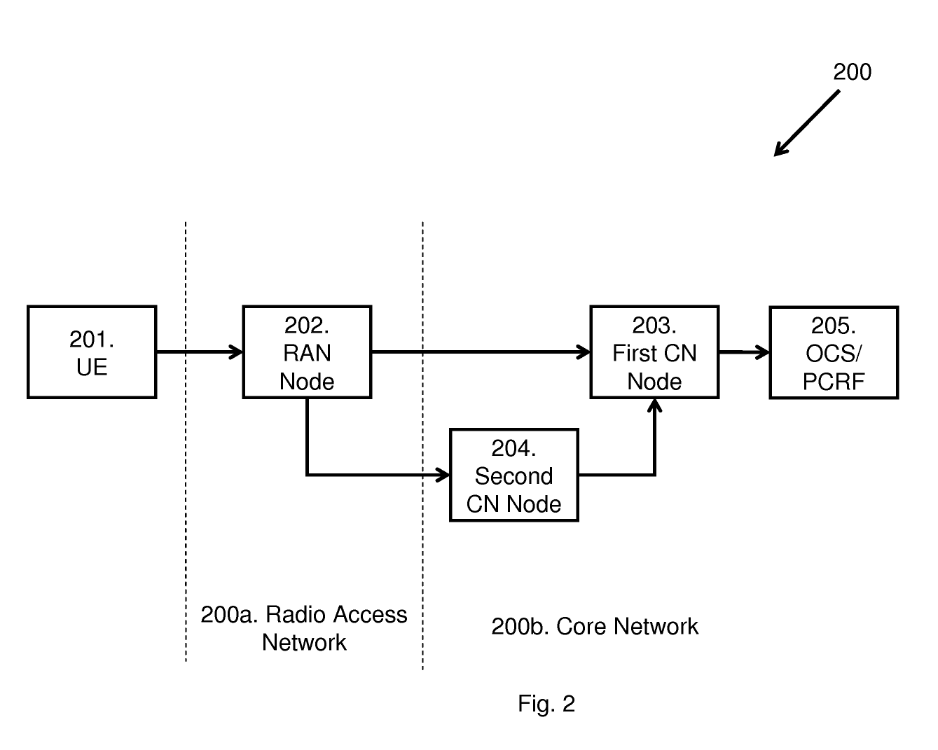

FIG. 2 depicts a communications network 200 in which embodiments herein may be implemented. The communications network 200 may in some embodiments apply to one or more radio access technologies such as for example GSM, WDMA, LTE, any other 3GPP radio access technology or other suitable radio access technologies. The communications network 200 comprises a radio access network 200a and a core network 200b.

The wireless communications network 200 comprises a user equipment 201 present within a cell and served by a radio access network node 202, and is in this case capable of communicating with the radio access network node 202 over a radio carrier. The radio access network node 202 may be a Base Station Controller (BSC), a Radio Network Controller (RNC), a base station such as an eNB, or any other network unit capable to communicate over a radio carrier with the user equipment 201. The radio access network node 202 is comprised in the radio access network 200a. The radio access network node will be referred to as a RAN node in some of the figures.

The user equipment 201 may be any device, mobile or stationary, enabled to communicate over the radio channel in the communications network, for instance but not limited to e.g. mobile phone, smart phone, sensors, meters, vehicles, household appliances, medical appliances, media players, cameras, or any type of consumer electronic, for instance but not limited to television, radio, lighting arrangements, tablet computer, laptop, or PC. The user equipment 201 is referred to as UE in some of the figures.

The radio access network 200a and the radio access network node 202 are connected to the core network 200b. In some embodiments, the radio access network node 202 is connected to a first core network node 203 in the core network 200b. The first core network node 203 may be a GGSN, a SGW or a PGW.

In some embodiments, the radio access network node 202 is connected to the first core network node 203 via a second core network node 204. The second core network node 204 may be a SGSN.

The first core network node 203 is connected to an OCS/PCRF 205, i.e. the first core network node 203 is connected to an OCS or a PCRF. The OCS/PCRF 205 is also comprised in the core network 200b. When the first core network node 203 is a GGSN, the GGSN is connected to the OCS via the Gy interface. At the same time, the GGSN may be connected to the PCRF via the Gx interface.

When the communications network 200 is a GSM network, the radio access network node 202 is a GERAN node such as the BSC, the first core network node 203 is a GGSN or a SGW/PGW and the second core network node 204 is a SGSN-MME. MME is for LTE access, and SGSN is for GSM and WCDMA.

When the communications network 200 is a WCDMA network, the radio access network node 202 is a UTRAN node such as the RNC, the first core network node 203 is a GGSN or a SGW/PGW and the second core network node 204 is a SGSN.

When the communications network 200 is a LTE network, the radio access network node 202 is an E-UTRAN node such as the eNB, the first core network node 203 is a SGW/PGW.

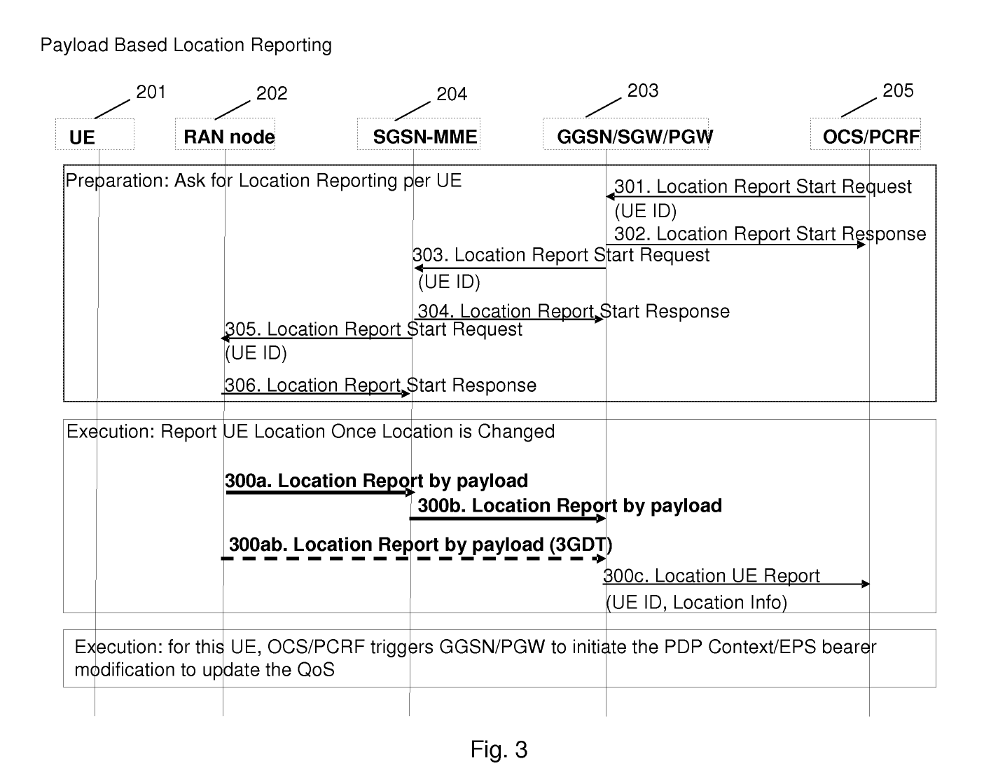

The payload based location reporting procedure for transmitting location information associated with the user equipment 201 to the first core network node 203 in the communications network 200 according to some embodiments will now be described with reference to the combined signaling diagram and flowchart depicted in FIG. 3. In FIG. 3, the first core network node 203 is referred to as GGSN/SGW/PGW and the second core network node 204 is referred to as SGSN-MME. The method comprises the following steps, which steps may as well be carried out in any other suitable order than described below.

### Step 301

Step 301 initiates the preparation stage by the OCS/PCRF 205 sending a Location Report Start Request to the first core network node 203, e.g. GGSN/SGW/PGW. Which of the nodes GGSN, SGW or PGW the request is sent to is dependent on whether the communications network is a GSM network, a WCDMA network or a LTE network. The Location Report Start Request comprises a user equipment ID.

### Step 302

Upon receipt of the Location Report Start Request, the first core network node 203, e.g. GGSN/SGW/PGW, sends a Location Report Start Response back to the OCS/PCRF 205 confirming that it has received the Location Report Start Request.

### Step 303

The first core network node 203, e.g. GGSN/SGW/PGW, forwards the Location Report Start Request comprising the user equipment ID to the second core network node 204, e.g. SGSN-MME.

### Step 304

Upon receipt of the Location Report Start Request, the second core network node 204, e.g. SGSN-MME, sends a Location Report Start Response back to the first core network node 203, e.g. GGSN/SGW/PGW.

### Step 305

The second core network node 204, e.g. SGSN-MME forwards the Location Report Start Request comprising the user equipment ID to the radio access network node 202.

### Step 306

Upon receipt of the Location Report Start Request, the radio access network node 202 sends a Location Report Start Response back to the second core network node 204, e.g. SGSN-MME. With this step 306, the preparation stage where the OCS/PCRF 205 asks for Location Reporting per user equipment is finished.

### Step 300a

After the preparation stage in steps 301-306 has been completed, the execution stage starts which involves reporting of the user equipment location once the location has changed, i.e. the user equipment 201 is moving. Step 300a may start directly after step 306 or it may start a time period after step 306.

The radio access network node 202 reports the changed location information to the second core network node 204, e.g. SGSN, by the payload data traffic using the GTP-U protocol or using UL-UNIDATA. The location information may be a CGI (GSM), SAI (WCDMA), or ECGI/TAI (LTE). The changed location information is enclosed in GTP-U header of the payload data traffic.

Payload data traffic, also referred to as the actual or body data, is the cargo of a data transmission. It is the part of the transmitted data which is the fundamental purpose of the transmission. The payload does not include the “overhead” data required to get the packet to its destination such as e.g. headers. The payload data traffic comprises, in addition to the location information, for example voice data, video data etc.

GTP is a group of IP-based communications protocols used to carry GPRS within GSM, UMTS and LTE networks. GTP may be decomposed into separate protocols: GTP-C, GTP-U and GTP′. GTP-C is used within the GPRS core network for signaling between the GGSN and the SGSN. GTP-U is used for carrying encapsulated payload data traffic and signaling messages within the GPRS core network and between the radio access network and the core network. For GTP-U protocol, it is GTPv1-U. Different GTP variants are implemented by RNCs, SGSNs, GGSNs, SGWs, PGWs within 3GPP networks.

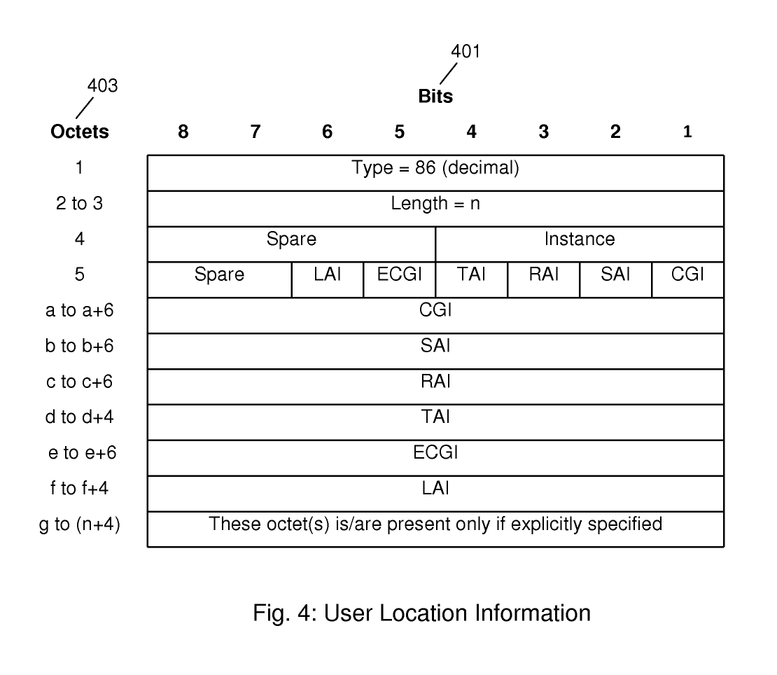

The location information indicated by User Location Information (ULI) is to be included into GTP-U header. The ULI is a variable length Information Element (IE) and it is coded as shown in FIG. 4. The vertical columns represent the bits 401 number 1 to 8 in the ULI and the horizontal rows represent the octets 403 in the ULI. The first octet 1 comprises the message type which is comprised in all bits 1 to 8. The Type=86 is the IE type of the ULI. The octets 2 to 3 comprise information about the length of the GTP-U header, and the length may be n, where n is a positive integer. The octet 4 comprises, in bits 1-4, the instance and the spare in bits 5-8. For a message, if there are several IEs having the same IE type, the instance is used to differentiate them. The spare bits are bits which are not used. The octet 5 comprises the flags for the identity types, with the CGI in bit 1, the SAI in bit 2, the RAI in bit 3, the TAI in bit 4, the ECGI in bit 5, the LAI in bit 6 and the spare in bits 7-8. The ULI IE shall contain only one identity of the same type (e.g. more than one CGI may not be included), but ULI IE may contain more than one identity of a different type (e.g. ECGI and TAI). The flags LAI, ECGI, TAI, RAI, SAI and CGI in octet 5 indicate if the corresponding type shall be present in a respective field or not. If one of these flags is set to “0”, the corresponding field shall not be present at all. If more than one identity of different type is present, then they shall be sorted in the following order: CGI, SAI, RAI, TAI, ECGI, LAI. If the flag for CGI in bit 1 in octet 5 is set to “1”, the octet a to a+6 is present, and if the octet is set to “0”, the octet a to a+6 is not present. 6 indicates the length of the CGI/SAI. If the flag for SAI in octet 5 is set to “1”, the octet b to b+6 is present and if the octet is set to “0”, the octet b to b+6 is not present. If the flag for RAI in octet 5 is set to “1”, the octet c to c+6 is present and if the octet is set to “0”, the octet c to c+6 is not present. If the flag for TAI in octet 5 is set to “1”, the octet d to d+4 is present and if the octet is set to “0”, the octet d to d+4 is not present. 4 is the length of TAI. If the flag for ECGI in octet 5 is set to “1”, the octet e to e+6 is present and if the octet is set to “0”, the octet e to e+6 is not present. If the flag for LAI in octet 5 is set to “1”, the octet f to f+4 is present and if the octet is set to “0”, the octet f to f+6 is not present. The octet g to (n+4) is/are present only if explicitly specified. The constants a, b, c, d, e and f are all positive integers.

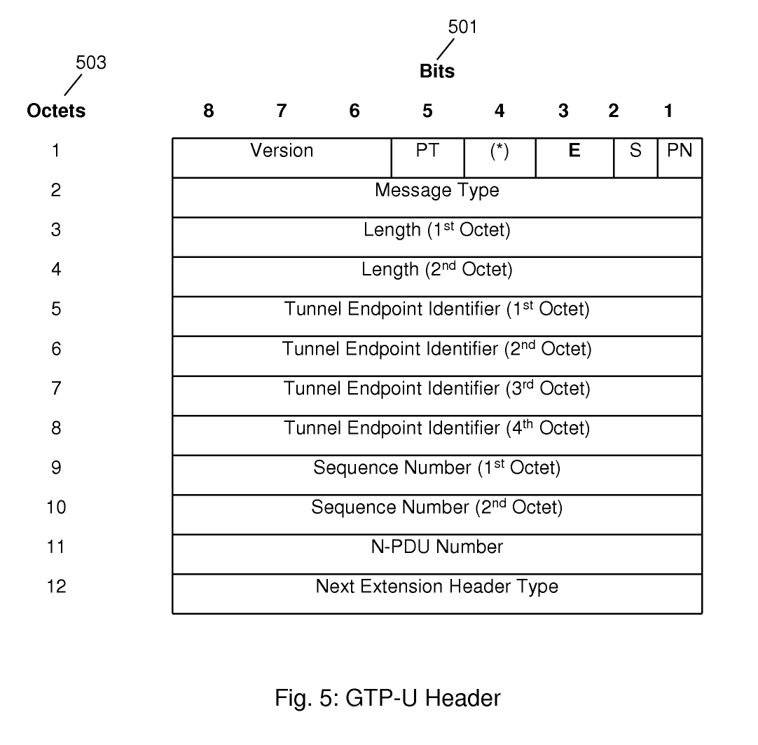

FIG. 5 illustrates the GTP-U header where the ULI IE is to be added as the Next Extension Header Type from Octet 12 of GTP-U header. The vertical columns represent the bits 501 which are 1-8 and the horizontal rows represent the octets 503. There are three flags that are used to signal the presence of additional optional fields: the Protocol Data Unit (PDU) number (PN) flag in bit 1 in octet 1, the Sequence number (S) flag in bit 2 in octet 1 and the Extension header (E) flag in bit 3 in octet 1. The PN flag is used to signal the presence of Network-PDU (N-PDU) Numbers. The S flag is used to signal the presence of the GTP-U sequence number field. The E flag is used to signal the presence of the extension header field, used to enable future extensions of the GTP-U header, without the need to use another version number. If and only if one or more of these three flags are set, the fields Sequence Number in octets 9 and 10, N-PDU in octet 11 and Extension Header in octet 12 shall be present. The sender of the payload data traffic, i.e. the radio access network node (SGSN), shall set all the bits of the unused fields to zero. The receiver of the payload data traffic (SGSN/GGSN) shall not evaluate the unused fields. For example, if only the E flag is set to 1, then the N-PDU Number and Sequence Number fields shall also be present, but will not have meaningful values and shall not be evaluated. The Sequence number in octets 9 and 10 are only evaluated when indicated by the S flag set to 1 and they are present if and only if any one or more of the S, PN and E flags are set. The N-PDU Number in octet 11 is only evaluated when indicated by the PN flag set to 1 and it is present if and only if any one or more of the S, PN and E flags are set. The Next Extension Header in octet 12 is only evaluated when indicated by the E flag set to 1 and is present if and only if any one or more of the S, PN and E flags are set.

In octet 1, bit 4 comprises a spare bit. It shall be set to “0”, and the receiver shall not evaluate this bit. In octet 1, bit 5 comprises information about the Protocol Type (PT) and is a bit used to differentiate between GTP (when PT is “1”) and GTP′ (when PT is “0”). Octet 1, bits 6-8, comprises a version field which is used to determine the version of the GTP-U protocol. The version number shall be set to ‘1’.

Octet 2 comprises the message type, i.e. it indicates the type of GTP-U message.

Octet 3 and octet 4 comprise information about the length in octets of the payload data traffic, i.e. the rest of the packet following the mandatory part of the GTP-U header (that is the first 8 octets). Octet 3 is represents the length of the first octet and octet 4 represents the length of the second octet.

Octets 5-8 in FIG. 5 comprise the TEID which is a field which unambiguously identifies a tunnel endpoint in the receiving GTP-U protocol entity. The receiving end side of a GTP locally assigns the TEID value the transmitting side has to use. The TEID in octet 5 represents the octet 1 of TEID, the TEID in octet 6 represents the octet 2 of TEID, the TEID in octet 7 represents the octet 3 of TEID and the TEID in octet 8 represents the octet 4 of TEID. The receiving GTP-U protocol entity may be the SGSN/GGSN.

Returning to FIG. 3.

### Step 300b

The second core network node 204, e.g. the SGSN, reports the changed location information to the first core network node 203, e.g. SGW/PGW, by the GTP-U header of payload data traffic using the GTP-U protocol. The GTP-U protocol may be the GTPv1-U protocol. The changed location information is enclosed in GTP-U header of the payload data traffic.

### Step 300ab

Step 300ab is performed instead of steps 300a and 300b. If 3GDT is used in a WCDMA network, the radio access network node 202 reports the changed location information to the first core network node 203, e.g. the GGSN/SGW, directly using the GTP-U protocol. 3GDT is a 3G Direct Tunnel allows data traffic to bypass the second core network node 204, i.e. the SGSN-MME, which significantly increases the throughput capacity in the core network. The changed location information is enclosed in GTP-U header of the payload data traffic.

### Step 300c

The first core network node 203, e.g. the GGSN or the SGW/PGW reports the changed location information to the OCS/PCRF 205 once this user equipment's location is changed. The changed location information is enclosed in GTP-U header of the payload data traffic. This completes the first part of the execution stage.

The second part of the execution stage takes place directly or a time after step 300c has been completed. The OCS/PCRF 205 receives the user equipment location information from the first core network node 203 and the OCS/PCRF 205 starts the location based charging or policy control, for example, initiates the QoS modification.

The method will now be described for when the communications network 200 is a GSM network, a WCDMA network and a LTE network.

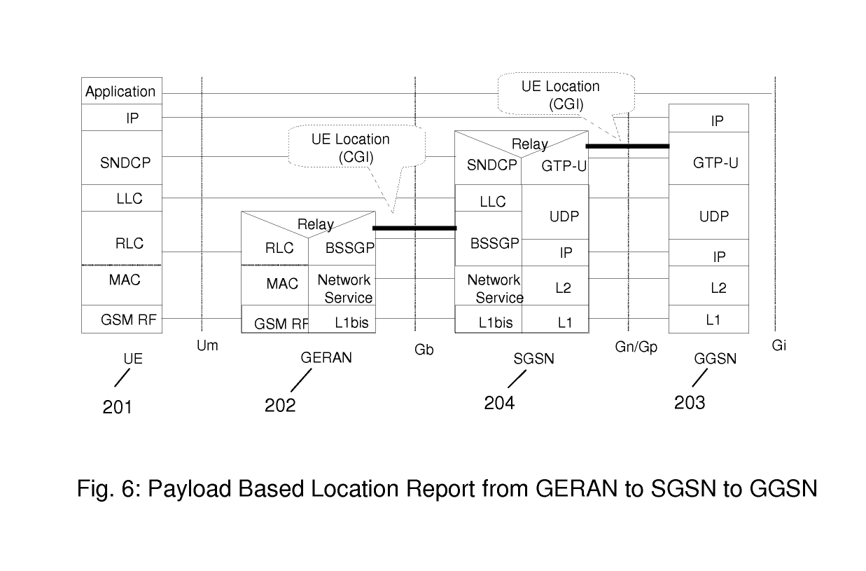

FIG. 6 is a schematic protocol stack diagram illustrating an embodiment of when the communications network 200 is a GSM network and when the location information is transmitted from the GERAN 202 via the SGSN 204 to the GGSN 203. In the embodiment in FIG. 6, the radio access network node 202 is represented by the GERAN, e.g. a BSC, the first core network node 203 is represented by the GGSN and the second core network node 204 is represented by the SGSN. In the GSM network, the location information is represented by the CGI. In the GSM network the GERAN 202, reports the location information to the SGSN 204 by using UpLink UNIDATA (UL-UNIDATA), in which the CGI is already carried. Then, the SGSN 204 reports the location information to the GGSN 203 by using the GTP-U payload data traffic, i.e. the GTP-U header of the GTP-U payload data traffic. The changed location information is enclosed in GTP-U header of the payload data traffic.

The physical layer is illustrated by the GSM Radio Frequency (GSM RF) for the user equipment 201, the GSM RF and L1bis for the GERAN 202, L1bis and L1 for the SGSN 204 and L1 for the GGSN 203 in FIG. 6.

In FIG. 6, the data link layer for the user equipment 201 is represented by the Medium Access Control (MAC), Radio Link Control (RLC) and Logical Link Control (LLC), it is represented by the MAC, RLC, Network Service and BSS GPRS Protocol (BSSGP) for the GERAN 202, it is represented by the Network Services, BSSGP, LLC, L2, Internet Protocol (IP) and User Datagram Protocol (UDP) for the SGSN 204 and it is represented by the L2, IP and UDP for the GGSN 203.

The network layer is illustrated by the SNDCP for the user equipment 201, the SNDCP and the GTP-U for the SGSN 204 and the GTP-U for the GGSN 203. The SNDCP is short for Sub Network Dependent Convergence Protocol and it is used to transfer data packets between the SGSN 204 and the user equipment 201. As seen in FIG. 6, the user location information, represented by the CGI, is transmitted using the BSSGP, i.e. UL-UNITDATA, between the GERAN 202 and the SGSN 204 and using the GTP-U protocol between the SGSN 204 and the GGSN 203. The changed location information is enclosed in GTP-U header of the payload data traffic.

On top of the protocol stack is the IP and the application layer. The relay represents the payload data traffic between the different nodes.

In FIG. 6, the interface between the user equipment 201 and the GERAN 202 is called Um and the interface between the GERAN 202 and the SGSN 204 is called Gb. The interface between the SGSN 204 and the GGSN 203 is the Gn/Gp interface. The interface between the GGSN 203 and the PDN (not shown) is referred to as Gi.

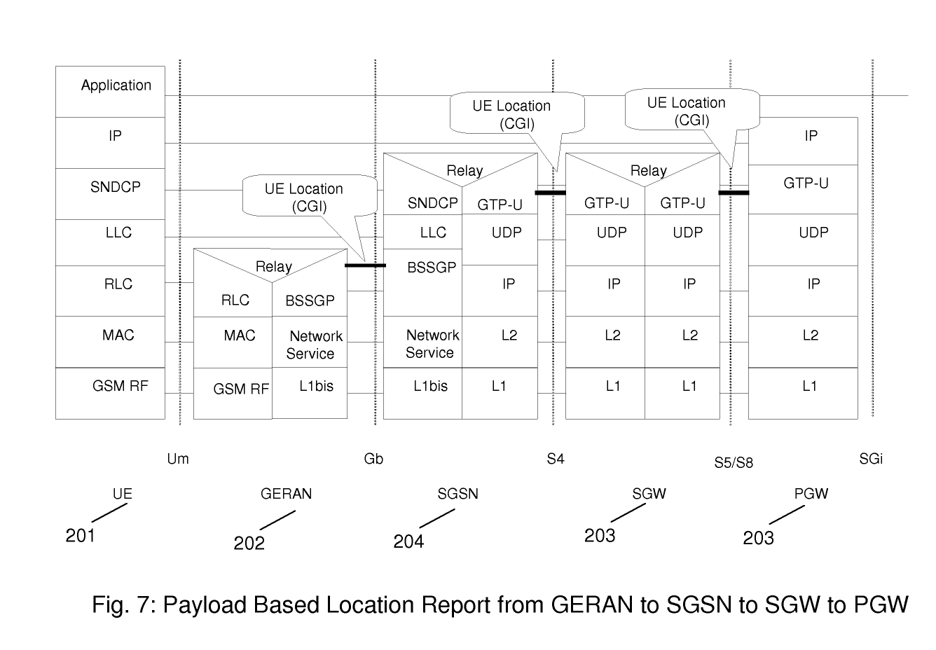

FIG. 7 is a schematic protocol stack diagram illustrating an embodiment of when the communications network 200 is a GSM network, and when the location information is transmitted from the GERAN 202 via the SGSN 204 to the SGW/PGW 203. In the embodiment in FIG. 7, the radio access network node 202 is represented by the GERAN, e.g. a BSC, the first core network node 203 is represented by the SGW/PGW and the second core network node 204 is represented by the SGSN. The GERAN 202 reports the location information to the SGSN 204 by using UL-UNITDATA in which the CGI is already carried. Then, the SGSN 204 reports the location information to the SGW/PGW 203 by using the GTP-U payload data traffic, i.e. the GTP-U header of the GTP-U payload data traffic. The GTP-U protocol may be the GTPv1-U protocol.

The physical layer is illustrated by the GSM RF for the user equipment 201, the GSM RF and L1bis for the GERAN 202, L1bis and L1 for the SGSN 204 and L1 for the SGW/PGW 203 in FIG. 7.

In FIG. 7, the data link layer for the user equipment 201 is represented by the MAC, RLC and LLC, it is represented by the MAC, RLC, Network Service and BSSGP for the GERAN 202, it is represented by the Network Services, BSSGP, LLC, L2, IP and UDP for the SGSN 204 and it is represented by the L2, IP and UDP for the SGW/PGW 203.

The network layer is illustrated by the SNDCP for the user equipment 201, the SNDCP and the GTP-U for the SGSN 204 and the GTP-U for the SGW/PGW 203. The SNDCP is used to transfer data packets between the SGSN 204 and the user equipment 201. As seen in FIG. 7, the user location information, represented by the CGI, is transmitted using the BSSGP, i.e. UL-UNITDATA, between the GERAN 202 and the SGSN 204 and using the GTP-U protocol between the SGSN 204 and the SGW/PGW 203. The changed location information is enclosed in GTP-U header of the payload data traffic.

On top of the protocol stack is the IP and the application layer. The relay represents the payload data traffic between the different nodes.

In FIG. 7, the interface between the UE 201 and the GERAN 202 is called Um and the interface between the GERAN 202 and the SGSN 204 is called Gb. The interface between the SGSN 204 and the SGW 203 is the S4 interface and the interface between the SGW 203 and the PGW 203 is the S5/S8 interface. The interface between the PGW 203 and the PDN (not shown) is called SGi.

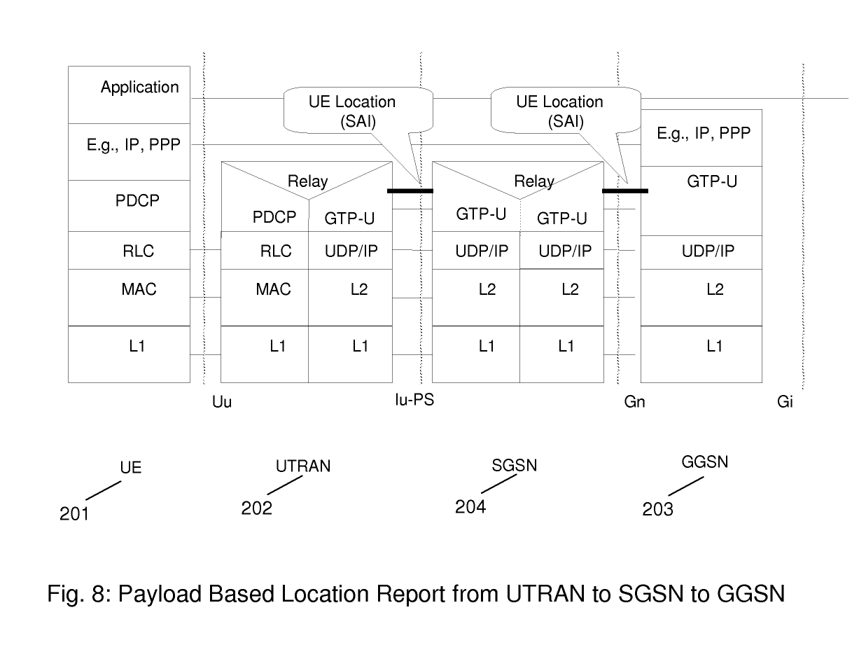

FIG. 8 is a schematic protocol stack diagram illustrating an embodiment of when the communications network 200 is a WCDMA network, and when the location information is transmitted from the UTRAN 202, i.e. the RNC, via the SGSN 204 to the GGSN 203 using the GTP-U payload data traffic. The changed location information is enclosed in GTP-U header of the payload data traffic. In the embodiment in FIG. 8, the radio access network node 202 is represented by the UTRAN, e.g. the RNC, the first core network node 203 is represented by the GGSN and the second core network node 204 is represented by the SGSN.

The physical layer is illustrated by the L1 for the user equipment 201, the UTRAN 202, the SGSN 204 and for the GGSN 203 in FIG. 8.

In FIG. 8, the data link layer for the user equipment 201 is represented by the MAC and RLC, it is represented by the MAC, RLC, L2 and UDP/IP for the UTRAN 202, and it is represented by the L2 and UDP/IP for the SGSN 204 and for the GGSN 203.

The network layer is illustrated by the PDCP for the user equipment 201, the PDCP and the GTP-U for the UTRAN, GTP-U for the SGSN 204 and for the GGSN 203. As seen in FIG. 8, the user location information, represented by the SAI, is transmitted using the GTP-U protocol from the UTRAN, via the SGSN 204, and to the GGSN 203. The changed location information is enclosed in GTP-U header of the payload data traffic.

On top of the protocol stack is the IP, PPP and the application layer. The relay represents the payload data traffic between the different nodes.

In FIG. 8, the interface between the user equipment 201 and the GERAN 202 is called Uu and the interface between the UTRAN 202 and the SGSN 204 is called lu-PS. The interface between the SGSN 204 and the GGSN 203 is the Gn interface. The interface between the GGSN 203 and the PDN (now shown) is the Gi interface.

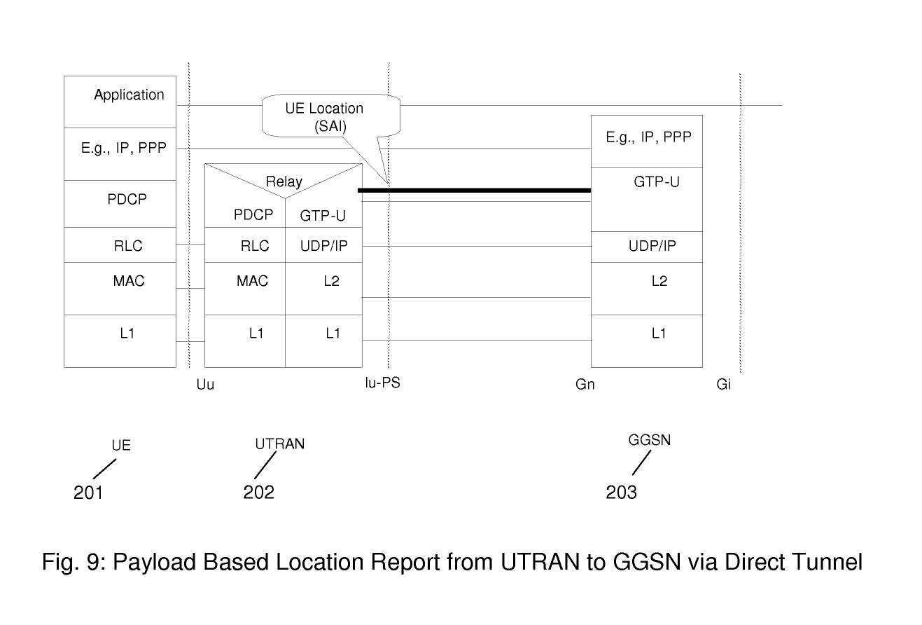

FIG. 9 is a schematic protocol stack diagram illustrating an embodiment of when the communications network 200 is a WCDMA network, and when the location information is transmitted from the UTRAN 202, i.e. the RNC, to the GGSN 203 via a Direct Tunnel and using the GTP-U payload data traffic. The changed location information is enclosed in GTP-U header of the payload data traffic. In the embodiment in FIG. 9 the radio access network node 202 is represented by the UTRAN, e.g. the RNC and the first core network node 203 is represented by the GGSN.

The physical layer is illustrated by the L1 for the user equipment 201, the UTRAN 202 and for the GGSN 203 in FIG. 9.

In FIG. 9, the data link layer for the user equipment 201 is represented by the MAC and RLC, it is represented by the MAC, RLC, L2 and UDP/IP for the UTRAN 202 and it is represented by the L2 and UDP/IP for the GGSN 203.

The network layer is illustrated by the PDCP for the user equipment 201, the PDCP and the GTP-U for the UTRAN and GTP-U for the GGSN 203. As seen in FIG. 9, the user location information, represented by the SAI, is transmitted using the GTP-U protocol directly from the UTRAN to the GGSN 203. The GTP-U protocol may be the GTPv1-U protocol. The changed location information is enclosed in GTP-U header of the payload data traffic.

On top of the protocol stack is the IP, PPP and the application layer. The relay represents the payload data traffic between the different nodes.

In FIG. 9, the interface between the user equipment 201 and the UTRAN 202 is called Uu and the interface after the UTRAN 202 is called lu-PS. The interface before the GGSN 203 is the Gn interface, and the interface between the GGSN 203 and the PDN (not shown) is the Gi interface.

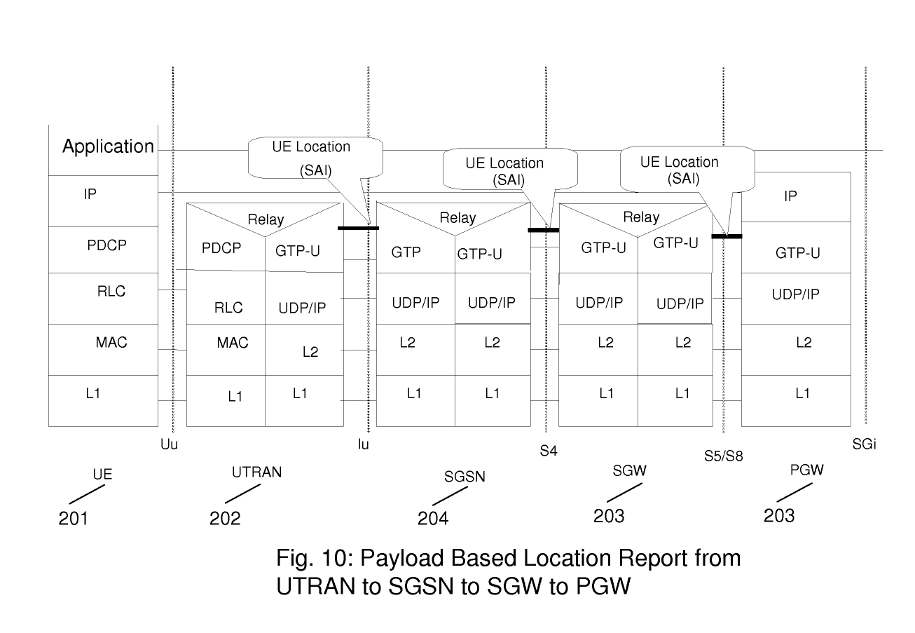

FIG. 10 is a schematic protocol stack diagram illustrating an embodiment of when the communications network 200 is a WCDMA network, and when the location information is transmitted from the UTRAN 202, i.e. the RNC, to the SGW/PGW 203 via the SGSN 204 and using the GTP-U payload data traffic. In the embodiment in FIG. 10, the radio access network node 202 is represented by the UTRAN, e.g. the RNC, the first core network node 203 is represented by the SGW/PGW and the second core network node 204 is represented by the SGSN.

The physical layer is illustrated by the L1 for the user equipment 201, the UTRAN 202, the SGSN 204 and for the SGW/PGW 203 in FIG. 10.

In FIG. 10, the data link layer for the user equipment 201 is represented by the MAC and RLC, it is represented by the MAC, RLC, L2 and UDP/IP for the UTRAN 202 and it is represented by the L2, UDP/IP for the SGSN 204 and the SGW/PGW 204.

The network layer is illustrated by the PDCP for the user equipment 201, the PDCP and the GTP-U for the UTRAN and GTP-U for the SGSN 204 and the SGW/PGW 203. As seen in FIG. 10, the user location information, represented by the SAI, is transmitted using the GTP-U protocol from the UTRAN 202 to the SGW/PGW 203 via the SGSN 204. The changed location information is enclosed in GTP-U header of the payload data traffic.

On top of the protocol stack is the IP, PPP and the application layer. The relay represents the payload data traffic between the different nodes.

In FIG. 10, the interface between the UE 201 and the UTRAN 202 is called Uu and the interface between the UTRAN 202 and the SGSN 204 is called lu. The interface between the SGSN 204 and the SGW 203 is the S4 interface, and the interface between the SGW 203 and the PGW 203 is the S5/S8 interface, and the interface between the PGW 203 and the PDN (not shown) is the SGi interface.

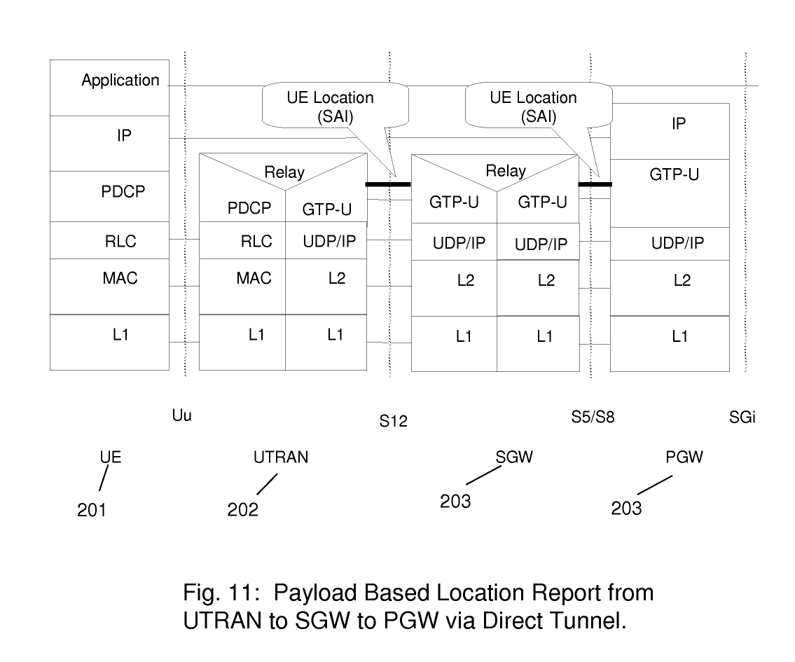

FIG. 11 is a schematic protocol stack diagram illustrating an embodiment of when the communications network 200 is a WCDMA network, and when the location information is transmitted directly from the UTRAN 202, i.e. the RNC, to the SGW/PGW 203 via a direct tunnel and using the GTP-U payload data traffic. The changed location information is enclosed in GTP-U header of the payload data traffic. In the embodiment in FIG. 11, the radio access network node 202 is represented by the UTRAN, e.g. the RNC, the first core network node 203 is represented by the SGW/PGW.

The physical layer is illustrated by the L1 for the user equipment 201, the UTRAN 202, the and for the SGW/PGW 203 in FIG. 11.

In FIG. 11, the data link layer for the user equipment 201 is represented by the MAC and RLC, it is represented by the MAC, RLC, L2 and UDP/IP for the UTRAN 202 and it is represented by the L2, UDP/IP for the SGW/PGW 204.

The network layer is illustrated by the PDCP for the user equipment 201, the PDCP and the GTP-U for the UTRAN and GTP-U for the SGW/PGW 203. As seen in FIG. 11, the user location information, represented by the SAI, is transmitted using the GTP-U protocol directly from the UTRAN 202 to the SGW/PGW 203 using a direct tunnel. The changed location information is enclosed in GTP-U header of the payload data traffic.

On top of the protocol stack is the IP, PPP and the application layer. The relay represents the payload data traffic between the different nodes.

In FIG. 11, the interface between the UE 201 and the UTRAN 202 is called Uu and the interface between the UTRAN 202 and the SGW 203 is the S12 interface, and the interface between the SGW 203 and the PGW 203 is the S5/S8 interface. The interface between the PGW 203 and the PDN (not shown) is the SGi interface.

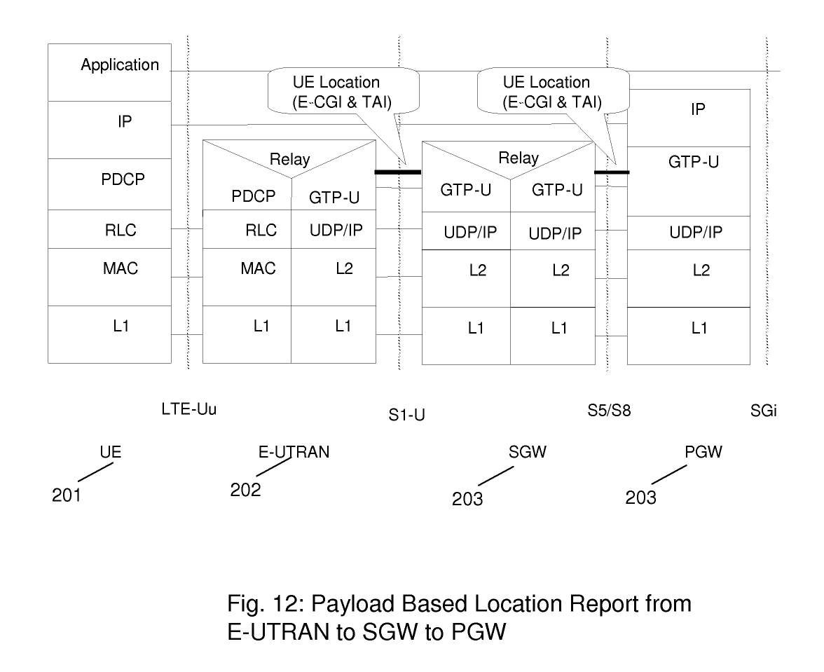

FIG. 12 is a schematic protocol stack diagram illustrating an embodiment of when the communications network 200 is a LTE network, and when the location information is transmitted directly from the E-UTRAN 202, i.e. the eNB, to the SGW/PGW 203 using the GTP-U payload data traffic. The changed location information is enclosed in GTP-U header of the payload data traffic. In the embodiment in FIG. 12, the radio access network node 202 is represented by the E-UTRAN, e.g. the eNB, the first core network node 203 is represented by the SGW/PGW.

The physical layer is illustrated by the L1 for the user equipment 201, the E-UTRAN 202 and for the SGW/PGW 203 in FIG. 12.

In FIG. 12, the data link layer for the user equipment 201 is represented by the MAC and RLC, it is represented by the MAC, RLC, L2 and UDP/IP for the E-UTRAN 202 and it is represented by the L2 and the UDP/IP for the SGW/PGW 204.

The network layer is illustrated by the PDCP for the user equipment 201, the PDCP and the GTP-U for the E-UTRAN 202 and GTP-U for the SGW/PGW 203. As seen in FIG. 12, the user location information, represented by the ECGI and TAI, is transmitted using the GTP-U protocol directly from the E-UTRAN 202 to the SGW/PGW 203. The changed location information is enclosed in GTP-U header of the payload data traffic.

On top of the protocol stack is the IP and the application layer. The relay represents the payload data traffic between the different nodes.

In FIG. 12, the interface between the UE 201 and the E-UTRAN 202 is called LTE-Uu and the interface between the E-UTRAN 202 and the SGW 203 is the S1-U interface, and the interface between the SGW 203 and the PGW 203 is the S5/S8 interface. The interface between the PGW 203 and the PDN (not shown) is the SGi interface.

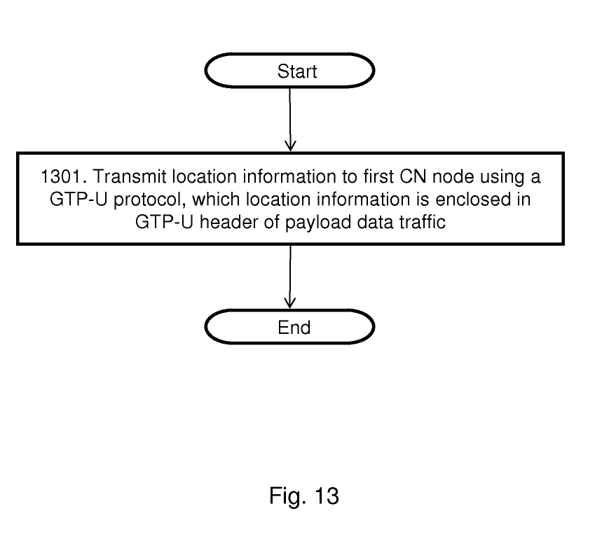

The method described above will now be described seen from the perspective of the radio access network node 202. FIG. 13 is a flowchart describing the present method in the radio access network node 202 for transmitting location information associated with a user equipment 201 to a first core network node 203 in a communications network 200. The method comprises the following step to be performed by radio access network node 202:

### Step 1301

This step corresponds to steps 300a, 300b, and 300ab in FIG. 3.

The radio access network node 202 transmits the location information to the first core network node 203 using the GTP-U protocol. The location information is enclosed in the GTP-U header of payload data traffic. The GTP-U protocol may be the GTPv1-U protocol. The location information is real-time information about the location of the user equipment 201. The location information may be a first location or a changed location. Real-time information is associated with something that occurs immediately, i.e. when the user equipment 201 changes location the location information about the changed location is transmitted immediately from the radio network node 202 to the first core network node 203.

In some embodiments, the location information is transmitted directly to the first core network node 203 or the location information is transmitted to the first core network node 203 via the second core network node 204.

In some embodiments, the payload data traffic is transmitted using the GTP-U protocol and using the UL-UNIDATA. The GTP-U protocol may be the GTPv1-U protocol. The changed location information is enclosed in GTP-U header of the payload data traffic.

In some embodiments, the location information is a CGI, a SAI, a, ECGI or a TAI.

In some embodiments, the location information is transmitted directly to the first core network node 203 using a Third Generation Direct Tunnel, 3GDT.

In some embodiments, the radio access network node 202 is represented by a BSC, a RNC or an eNB.

In some embodiments, the first core network node 203 is represented by a GGSN, a SGW or a PGW.

In some embodiments, the second core network node 204 is represented by a SGSN.

In some embodiments, the communications network 200 is based on GSM, WCDMA or LTE.

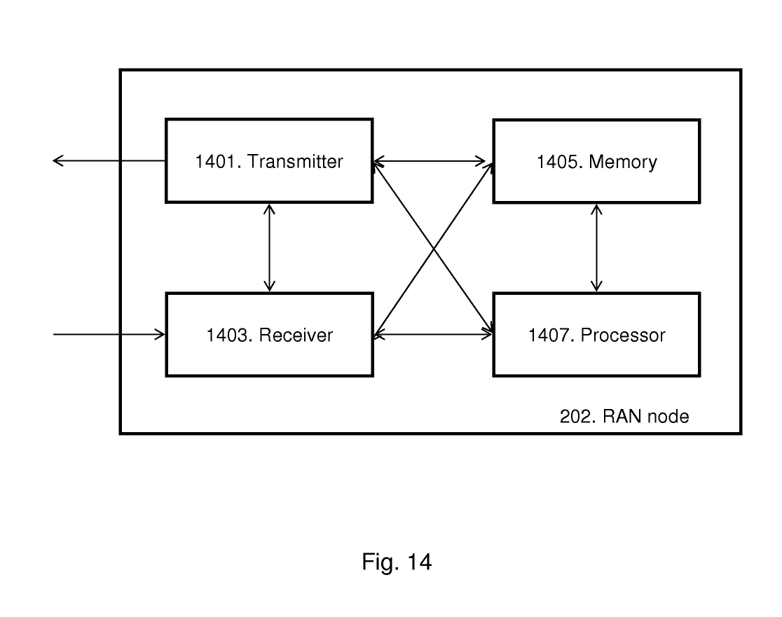

To perform the method steps shown in FIG. 13 for transmitting location information associated with a user equipment 201 to a first core network node 203 in a communications network 200, the radio access network node 202 comprises an arrangement as shown in FIG. 14. In some embodiments, the radio access network node 202 is represented by a BSC, a RNC, or an eNB. In some embodiments, the communications network 200 is based on GSM, WCDMA or LTE. In some embodiments, the first core network node 203 is represented by a GGSN, a SGW or a PGW.

The radio access network node 202 comprises a transmitter 1401 configured to transmit the location information to the first core network node 203 using the GTP-U protocol. The location information is enclosed in payload data traffic. The location information is enclosed in GTP-U header of the payload data traffic. The transmitter 1401 may be further configured to transmit the location information directly to the first core network node or to transmit the location information to the first core network node via a second core network node. In some embodiments, the transmitter 1401 is further configured to transmit the payload data traffic using the GTP-U protocol or using the GTP-U protocol and the UL-UNIDATA. The GTP-U protocol may be the GTPv1-U protocol. In some embodiments, the location information is a CGI, a SAI, an ECGI or a TAI. In some embodiments, the transmitter 1401 is further configured to transmit the location information directly to the first core network node 203 using a 3GDT. In some embodiments, the second core network node 204 is represented by a SGSN.

The radio access network node 202 may further comprise a receiver 1403 configured to receive a Location Report Start Request from the first core network node 203 and/or from the second core network node 204. The receiver 1403 may also be configured to receive information from the user equipment 201 about a changed location.

The radio access network node 202 may further comprise a memory 1405 comprising one or more memory units. The memory 1405 is arranged to be used to store data, received data streams, threshold values, time periods, configurations, scheduling's, and applications to perform the methods herein when being executed in the radio access network node 202.

The present mechanism for transmitting location information associated with a user equipment 201 to a first core network node 203 in a communications network 200 may be implemented through one or more processors, such as a processor 1407 in the user equipment arrangement depicted in FIG. 14, together with computer program code for performing the functions of the embodiments herein. The processor may be for example a Digital Signal Processor (DSP), Application Specific Integrated Circuit (ASIC) processor, Field-programmable gate array (FPGA) processor or microprocessor. The program code mentioned above may also be provided as a computer program product, for instance in the form of a data carrier carrying computer program code for performing the embodiments herein when being loaded into the radio access network node 202. One such carrier may be in the form of a CD ROM disc. It is however feasible with other data carriers such as a memory stick. The computer program code may furthermore be provided as pure program code on a server and downloaded to the radio access network node 202.

Those skilled in the art will also appreciate that the transmitter 1401 and the receiver 1403 described above may refer to a combination of analog and digital circuits, and/or one or more processors configured with software and/or firmware, e.g. stored in a memory, that when executed by the one or more processors such as the processor 1407 perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

The embodiments herein are not limited to the above described embodiments. Various alternatives, modifications and equivalents may be used. Therefore, the above embodiments should not be taken as limiting the scope of the embodiments, which is defined by the appending claims.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

It should also be emphasized that the steps of the methods defined in the appended claims may, without departing from the embodiments herein, be performed in another order than the order in which they appear in the claims.

1. A method in a radio access network node for transmitting location information associated with a user equipment to a first core network node in a communications network, the method comprising:
transmitting the location information to the first core network node using a General packet radio service Tunneling Protocol-User plane, GTP-U, protocol, which location information is enclosed in a GTP-U header of payload data traffic.

2. The method according to claim 1, wherein the location information is transmitted directly to the first core network node or wherein the location information is transmitted to the first core network node via a second core network node.

3. The method according to any of the claim 1, wherein the payload traffic is transmitted using the GTP-U, protocol and using an UpLink UNIDATA, UL-UNIDATA.

4. The method according to any of the claim 1, wherein the location information is a Cell Global Identity, CGI, or a Service Area Identifier, SAI, or a Evolved universal terrestrial radio access network-Cell Global Identifier, ECGI, or a Tracking Area Identity, TAI.

5. The method according to any of the claim 1, wherein the location information is transmitted directly to the first core network node using a Third Generation Direct Tunnel, 3GDT.

6. The method according to any of the claim 1, wherein the radio access network node is represented by a Base Station Controller, BSC, a Radio Network Controller, RNC, or an evolved NodeB, eNB.

7. The method according to any of the claim 1, wherein the first core network node is represented by a Gateway General packet radio service Support Node, GGSN, a Serving GateWay, SGW, or a Packet data network GateWay, PGW.

8. The method according to any of the claim 2, wherein the second core network node is represented by a Serving General packet radio service Support Node, SGSN.

9. The method according to any of the claim 1, wherein the communications network is based on Global System for Mobile Communications, GSM, or based on Wideband Code Division Multiple Access, WCDMA, or based on Long Term Evolution, LTE.

10. A radio access network node for transmitting location information associated with a user equipment to a first core network node in a communications network, the radio access network node comprising:
a transmitter configured to transmit the location information to the first core network node using a General packet radio service Tunneling Protocol-User plane, GTP-U, protocol, which location information is enclosed in a GTP-U header of payload data traffic.

11. The radio access network node according to claim 10, wherein transmitter is further configured to transmit the location information directly to the first core network node or wherein to transmit the location information to the first core network node via a second core network node.

12. The radio access network node according to claim 10, wherein the transmitter is further configured to transmit the payload traffic using the GTP-U, protocol and using an UpLink UNIDATA, UL-UNIDATA.

13. The radio access network node according to claim 10, wherein the location information is a Cell Global Identity, CGI, or a Service Area Identifier, SAI, or a Evolved universal terrestrial radio access network-Cell Global Identifier, ECGI, or a Tracking Area Identity, TAI.

14. The radio access network node according to claim 10, wherein the transmitter is further configured to transmit the location information directly to the first core network node using a Third Generation Direct Tunnel, 3GDT.

15. The radio access network node according to claim 10, wherein the RAN node is represented by a Base Station Controller, BSC, a Radio Network Controller, RNC, or an evolved NodeB, eNB.

16. The radio access network node according to claim 10, wherein the first core network node is represented by a Gateway General packet radio service Support Node, GGSN, a Serving GateWay, SGW, or a Packet data network GateWay, PGW.

17. The radio access network node according to claim 11, wherein the second core network node is represented by a Serving General packet radio service Support Node, SGSN.

18. The radio access network node according to claim 10, wherein the communications network is based on Global System for Mobile Communications, GSM, or based on Wideband Code Division Multiple Access, WCDMA, or based on Long Term Evolution, LTE.
